(19) United States
(12) Patent Application Publication
(10) Pub. No.: US 2011/0025463 A1
(43) Pub. Date: Feb. 3, 2011

(54) Parallel Antennas for Contactless Device

(75) Inventors: Romain Palmade, Auriol (FR); Pierre Benet, Aix en Provence (FR)

Correspondence Address: FISH & RICHARDSON P.C. (SV), PO BOX 1022, MINNEAPOLIS, MN, 55440-1022, US

(73) Assignee: Atmel Corporation, San Jose, CA (US)

(21) Appl. No.: 12/534,726

(22) Filed: Aug. 3, 2009

(51) Int. Cl. H04Q 5/22; G06K 19/06; H01Q 21/00; H01Q 7/00

(52) U.S. Cl. 340/10.1; 235/493; 343/867

(57) ABSTRACT

An electronic information device includes an integrated circuit embedded within the device. The electronic information device further includes a first antenna that is embedded within the device and is connected to the integrated circuit. The electronic information device further includes a second antenna that is embedded within the device and is connected to the integrated circuit. The first antenna is oriented within a first plane and the second antenna is oriented within a second plane that is substantially parallel to the first plane.

### BACKGROUND

RFID devices are presently manufactured and used to track a variety of items, transactions and materials. Contactless smart card technology is used in applications that need to protect personal information and/or deliver secure transactions, such as transit fare payment cards, government and corporate identification cards, electronic passports and visas, and financial payment cards. Contactless smart card technology is used in a variety of devices such as plastic cards, watches, key fobs, documents, and other handheld devices.

RFID technology allows persons or objects to be identified and permits detailed information to be stored within an individual RFID device. As an example, a card owner's personal information, such as an encoded cryptographically signed copy of a photograph, signature, fingerprints, and other biometrics data, may be securely stored in an RFID device.

The RFID device typically includes an integrated circuit (IC) chip and an antenna embedded within the RFD) device. An RFID device may also have a battery included in the device or may be passive. A passive RFID device, which has no batteries or power source of its own, relies on getting it's power from an RFID reader's RF signal in order to operate. When the RFID device is brought into an electromagnetic field generated by the reader, the IC chip in the RFID device powers on. Once the IC chip is powered on, a wireless communication protocol is initiated and established between the card and the reader for data transfers.

RFID devices such as smart cards may receive commands and update the information stored in the RFID device. An RFID reader typically sends RF signals to an RFID device using magnetic and/or electromagnetic fields to both power the card and to exchange data between the RFID device and the reader. When the RFID device or tag receives the reader's signal, the RFID tag or device sends stored data to the reader and the reader receives and decodes the data that is programmed into the contactless device.

### SUMMARY

An electronic information device includes an integrated circuit embedded within the device. The electronic information device further includes a first antenna that is embedded within the device and is connected to the integrated circuit. The electronic information device further includes a second antenna that is embedded within the device and is connected to the integrated circuit. The first antenna is oriented within a first plane and the second antenna is oriented within a second plane that is substantially parallel to the first plane.

### BRIEF DESCRIPTION OF THE DRAWINGS

FIG. 1 is a perspective view of an electronic information device according to an example embodiment.

FIG. 2 is a perspective view illustrating an enlarged portion of the electronic information device shown in FIG. 1.

FIG. 3 is a plan view of the electronic information device shown in FIG. 1.

FIG. 4 is a schematic side view of a portion of the electronic information device shown in FIG. 1.

FIG. 5 is a perspective view similar to FIG. 1 where the antennas within the electronic information device are offset according to an example embodiment.

FIG. 6 is a plan view of the electronic information device shown in FIG. 5.

FIG. 7 is a plan view similar to FIGS. 3 and 5 where the electronic information device includes a magnetic strip according to an example embodiment.

FIG. 8 is a perspective view of an electronic information device according to another example embodiment.

FIG. 9 is a perspective view illustrating an enlarged portion of the electronic information device shown in FIG. 8.

FIG. 10 is a plan view of the electronic information device shown in FIG. 8.

FIG. 11 is a schematic side view of a portion of the electronic information device shown in FIG. 8.

FIG. 12 is a perspective view similar to FIG. 8 where the antennas within the electronic information device are offset according to an example embodiment.

FIG. 13 is a plan view of the electronic information device shown in FIG. 12.

FIG. 14 is a plan view similar to FIGS. 10 and 12 where the electronic information device includes a magnetic strip according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

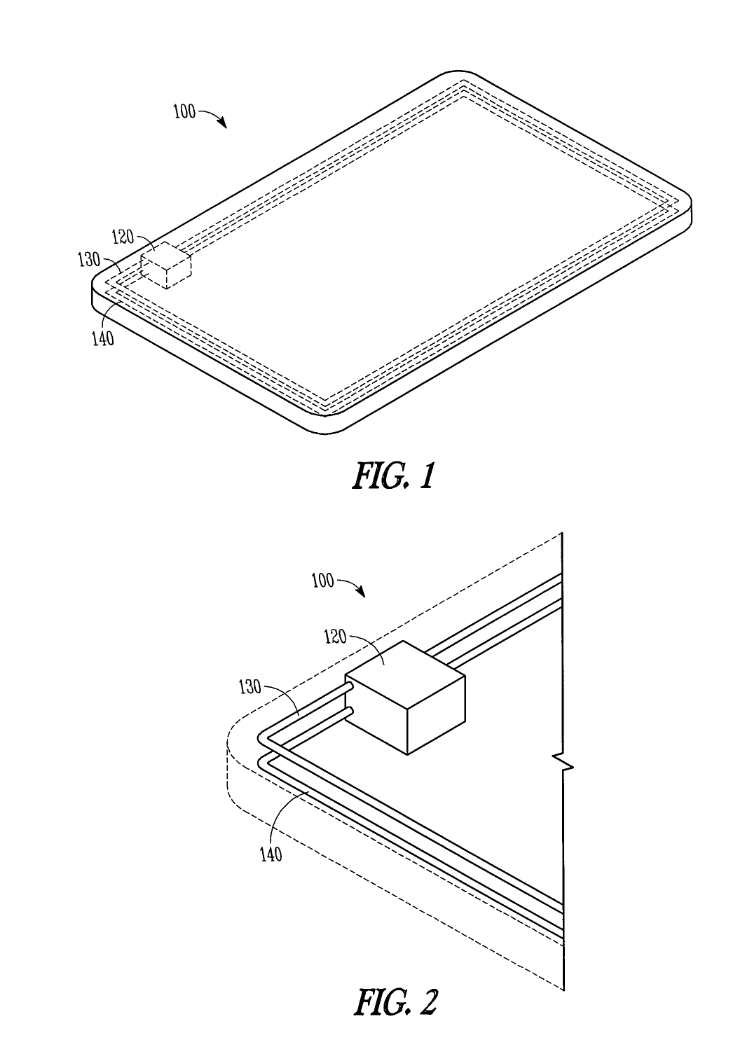

FIGS. 1 through 7 illustrate an electronic information device 100 according to example embodiments. The electronic information device 100 includes an integrated circuit 120 that is embedded within the device 100.

The electronic information device 100 further includes a first antenna 130 that is embedded within the device 100 and is connected to the integrated circuit 120. The first antenna 130 is oriented within a first plane.

The electronic information device 100 further includes a second antenna 140 that is embedded within the device 100 and is connected to the integrated circuit 120. The second antenna 140 is oriented within a second plane where the second plane is substantially parallel to the first plane.

The first and second antennas 130, 140 are designed to send and receive wireless signals to and from the integrated circuit 120. The type of wireless signals, as well as how the signals are utilized by the integrated circuit 120, will depend on the application where the device 100 is utilized.

Placing the first and second antennas 130, 140 in parallel within the device increases the overall area of the antenna without significantly increasing the area of the device 100. Each antenna may run close to the perimeter of the device 100 since they are different planes.

In addition, the first and second antennas 130, 140 are connected to the integrated circuit 120 in parallel such that the first and second antennas 130, 140 are able to receive more power from an electromagnetic source (e.g., a card reader) which can then be supplied to the integrated circuit 120 when the device 100 is a passive device. Connecting the antennas 130, 140 in parallel will put the resistances of antennas 130, 140 in parallel thereby decreasing the resistance of the overall antenna system. Lowing the overall resistance of the antenna system will result in lower natural power losses during operation of the device.

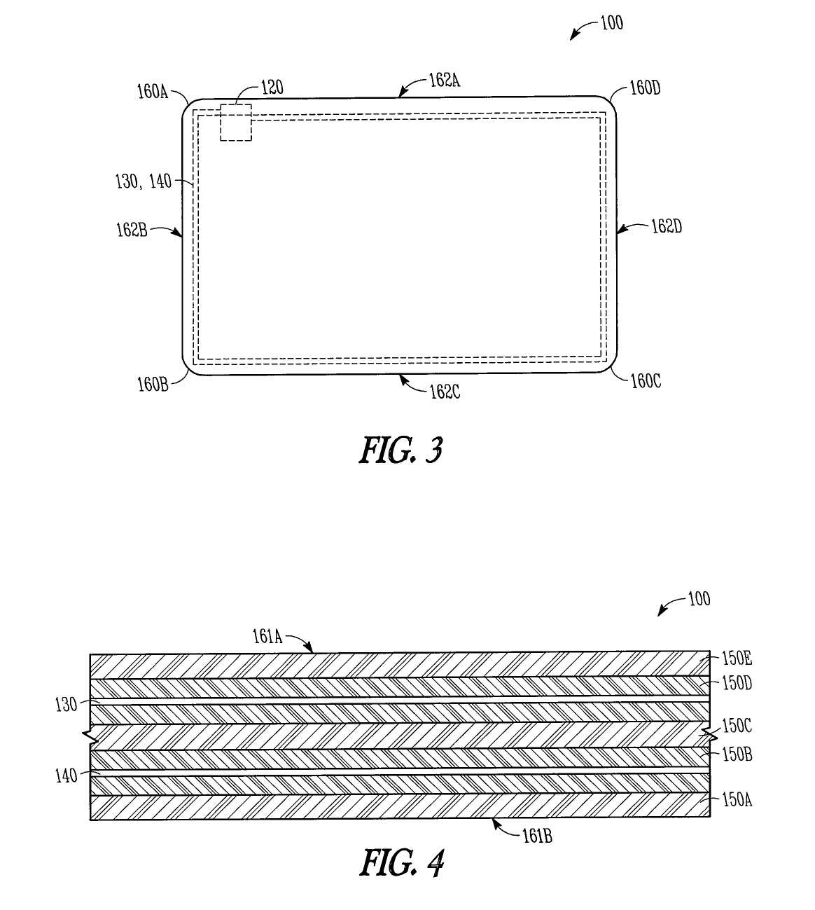

In the example embodiment illustrated in FIG. 3, the first and second antennas 130, 140 are coil antennas that each include multiple loops (two loops are shown corresponding to the first and second antennas 130, 140 in FIG. 3). In other embodiments, the first and second antennas 130, 140 may include a different number of loops or may be a different type of antenna.

In the example embodiment illustrated in FIGS. 1 through 3, the first and second antennas 130, 140 are aligned. In some embodiments, the device 100 includes four corners 160A, 160B, 160C, 160D such that a portion of the first antenna 130 is positioned adjacent to each of the corners 160A, 160B, 160C, 160D and a portion of the second antenna 140 is positioned adjacent to each of the corners 160A, 160B, 160C, 160D (shown most clearly in FIGS. 1 and 3).

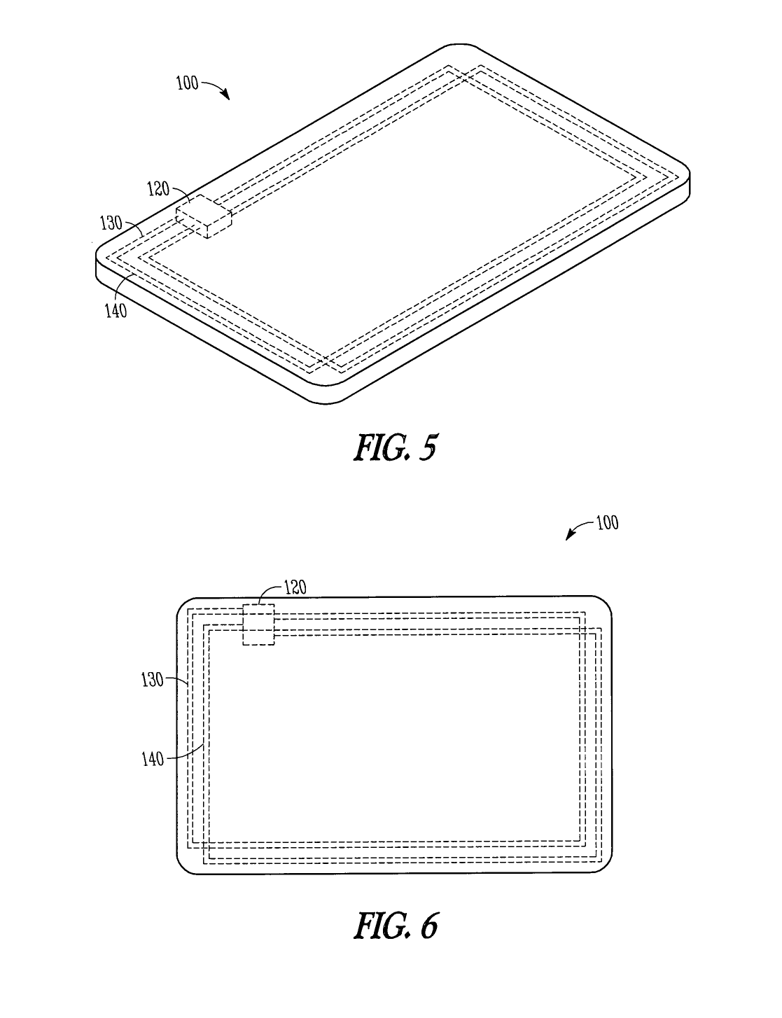

FIG. 4 shows an example embodiment where the device 100 includes multiple layers 150A, 150B, 150C, 150D, 150E such that the first antenna 130 is in a first layer 150B and the second antenna 140 in a second layer 150D that is not adjacent to the first layer 130. In other embodiments, the device 100 may include a different number of layers and/or the first and second antennas 130, 140 may be separated by more than one layer.

FIG. 4 shows that the device 100 includes an upper surface 161A, a lower surface 161B while FIG. 3 shows that the device includes outer edges 162A, 162B, 162C, 162D such that the first and second antennas 130, 140 are positioned adjacent to the outer edges 162A, 162B, 162C, 162D of the device 100. In addition, the first and second antennas 130, 140 may be positioned between the upper surface 161A and the lower surface 161B of the device 100.

In the example embodiment illustrated in FIGS. 5 and 6, the first and second antennas 130, 140 are offset from one another. Offsetting the first and second antennas 130, 140 relative to one another such that the first antenna 130 is horizontally staggered relative to the second antenna 140 may enhance the coupling between the first and second antennas 130, 140. Offseting the antennas will modify the coupling of each antenna 130, 140 with any reader coil that are used in conjunction with the device 100. Each antenna 130, 140 becomes independently coupled to such reader coil such that two independent current sources are delivered to the integrated circuit 120 thereby providing more energy to the integrated circuit 120. The degree to which the first and second antennas 130, 140 are offset will depend in part on the (i) the desired range of the device 100; (ii) the size of the first and second antennas 130, 140; (iii) the size of the device 100; and (iv) the number of loops in the first and second antennas 130, 140 (among other factors).

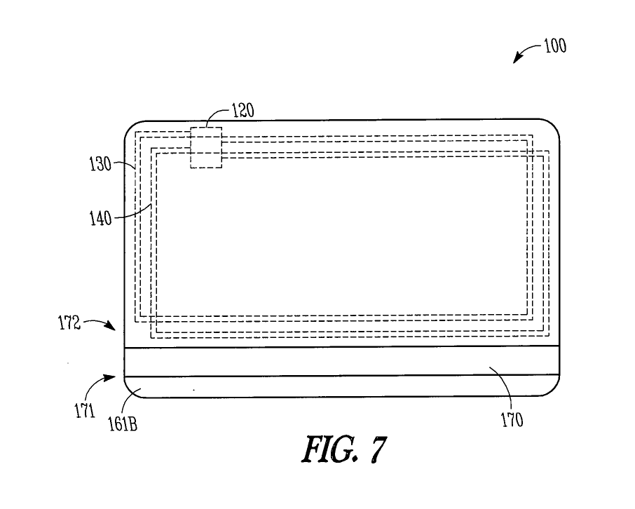

FIG. 7 shows an example embodiment where the device 100 further includes a magnetic strip 170 on the lower surface 161B of the device 100. In other embodiments, the magnetic strip 170 may be on the upper surface 161A of the device 100.

In the example embodiment illustrated in FIG. 7, the device 100 includes a first area 171 and a second area 172 that is adjacent to the first area 171. The magnetic strip 170 is positioned in the first area 171 while the first and second antennas 130, 140 are positioned in the adjacent second area 172. The magnetic strip 170 and the first and second antennas 130, 140 need to be positioned in the adjacent areas of the device 100 because the magnetic strip will interfere with the operation of the antennas 130, 140 if there is any overlap between the magnetic strip 170 and the first and second antennas 130, 140.

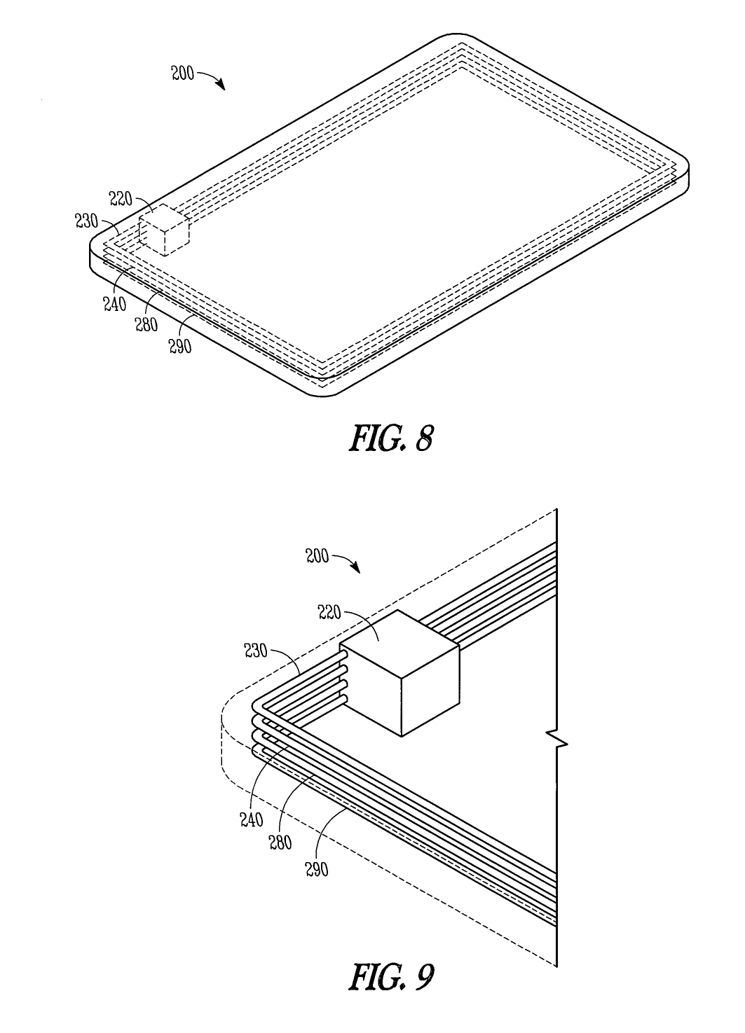

FIGS. 8 through 14 illustrate an electronic information device 200 according to another example embodiment. The electronic information device 200 includes an integrated circuit 220 that is embedded within the device 200.

The electronic information device 200 further includes a first antenna 230 that is embedded within the device 200 and is connected to the integrated circuit 220. The first antenna 230 is oriented within a first plane.

The electronic information device 200 further includes a second antenna 240 that is embedded within the device 200 and is connected to the integrated circuit 220. The second antenna 240 is oriented within a second plane where the second plane is substantially parallel to the first plane.

The electronic information device 200 further includes a third antenna 280 that is embedded within the device 200 and is connected to the integrated circuit 220. The third antenna 280 is oriented within a third plane where the third plane is substantially parallel to the first plane and the second plane.

The electronic information device 200 further includes a fourth antenna 290 that is embedded within the device 200 and is connected to the integrated circuit 220. The fourth antenna 290 is oriented within a fourth plane where the fourth plane is substantially parallel to the first plane, the second plane and the third plane.

The first, second, third and fourth antennas 230, 240, 280, 290 are designed to send and/or receive wireless signals to and/or from the integrated circuit. The type of wireless signals, as well as how the signals are utilized by the integrated circuit 220, will depend on the application where the device 200 is utilized.

In the example embodiment illustrated in FIG. 10, the first, second, third and fourth antennas 230, 240, 280, 290 are coil antennas that are aligned and each include multiple loops (two loops are shown in FIG. 10). As shown most clearly in FIG. 10, the device 200 includes four corners 260A, 260B, 260C, 260D such that a portion of each of the first, second, third and fourth antennas 230, 240, 280, 290 is positioned adjacent to each of the corners 260A, 260B, 260C, 260D.

In other embodiments, the first, second, third and fourth antennas 230, 240, 280, 290 may include a different number of loops or be a different type of antenna. Although the device 200 is shown as having four antennas 230, 240, 280, 290, it should be noted that the device 200 may include three antennas or more than four antennas in other embodiments.

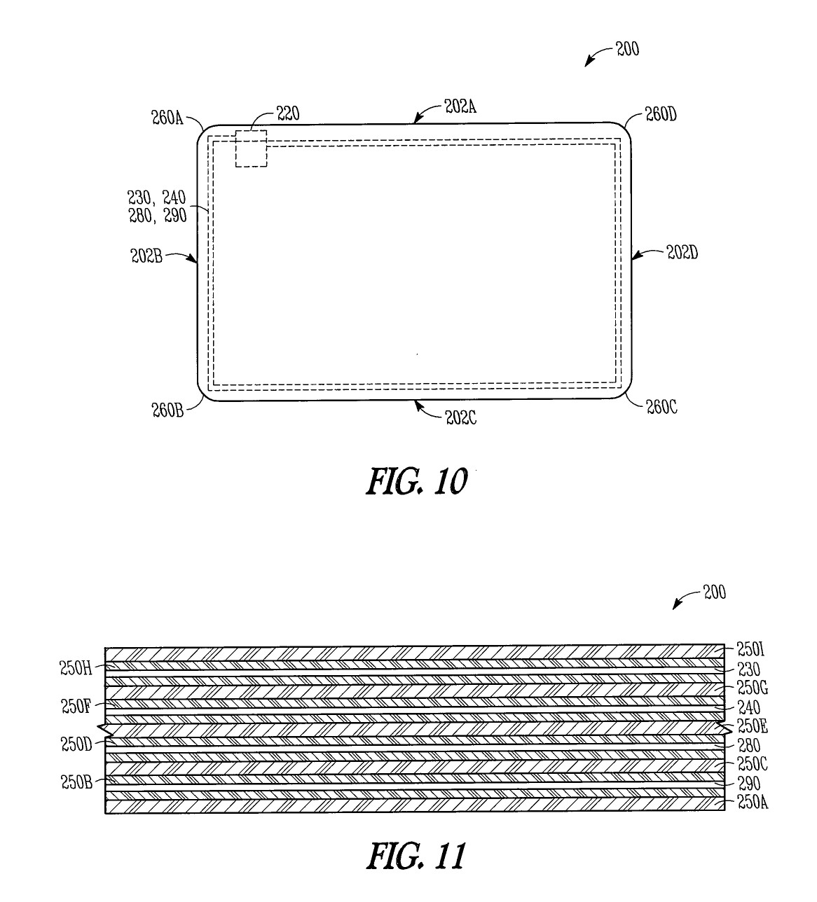

FIG. 11 shows an example embodiment where the device 200 includes multiple layers 250A, 250B, 250C, 250D, 250E, 250F, 250G, 250H, 2501. The first antenna 230 is in a first layer 250B and the second antenna 240 in a second layer 250D that is not adjacent to the first layer 250B. The third antenna 280 is in a third layer 250F that is not adjacent to the first layer 250B or the second layer 250D. The fourth antenna 290 is in a fourth layer 250H that is not adjacent to the first layer 250B, the second layer 250D or the third layer 250F. In other embodiments, the device 200 may include a different number of layers and/or the first, second, third and fourth antennas 230, 240, 280, 290 may be separated by more than one layer.

In some embodiments, the device includes an upper surface 262A, a lower surface 262B and outer edges 262A, 262B, 262C, 262D such that each of the first, second, third and fourth antennas 230, 240, 280, 290 is positioned adjacent to the outer edges 262A, 262B, 262C, 262D of the device 200. In addition, the first, second, third and fourth antennas 230, 240, 280, 290 may be positioned between the upper surface 262A and the lower surface 262B of the device 200.

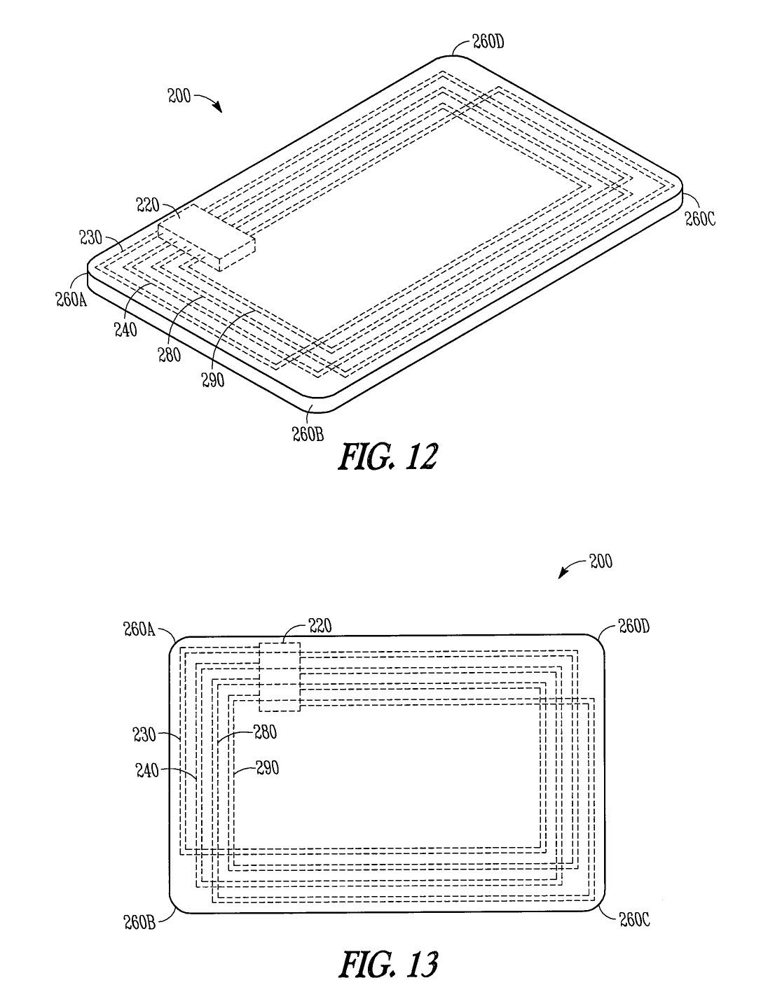

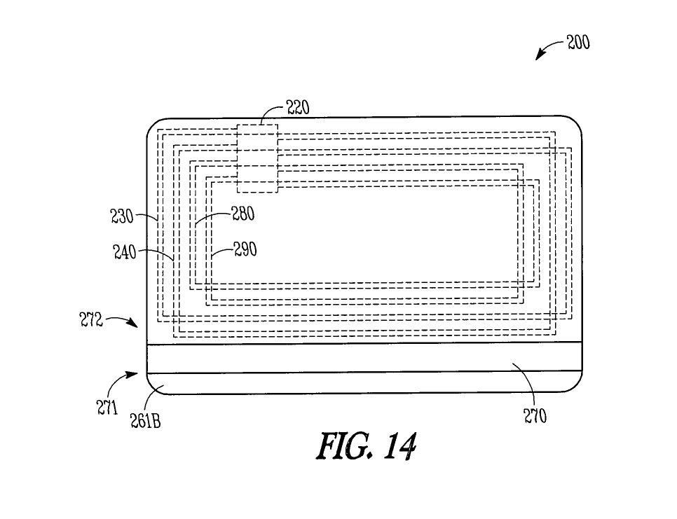

In the example embodiment illustrated in FIGS. 12 and 13, the first, second, third and fourth antennas 230, 240, 280, 290 are offset from one another. As shown on FIGS. 12 and 13, the first, second, third and fourth antennas 230, 240, 280, 290 may be arranged within the device 200 such that a portion of each of the antennas 230, 240, 280, 290 is adjacent to a unique one of the four corners 260A, 260B, 260C, 260D. Offsetting the first, second, third and fourth antennas 230, 240, 280, 290 relative to one another in this manner such that the first, second, third and fourth antennas 230, 240, 280, 290 are horizontally staggered relative to one another may enhance the coupling between the first, second, third and fourth antennas 230, 240, 280, 290. The degree to which the first, second, third and fourth antennas 230, 240, 280, 290 are offset will depend in part on the (i) the desired range of the device 200; (ii) the size of the first, second, third and fourth antennas 230, 240, 280, 290; (iii) the size of the device 200; and (iv) the number of loops in the first, second, third and fourth antennas 230, 240, 280, 290 (among other factors).

FIG. 14 shows an example embodiment where the device 200 further includes a magnetic strip 270 on the lower surface 262B of the device 200. In other embodiments, the magnetic strip 270 may be on the upper surface 262A of the device 200.

In the example embodiment illustrated in FIG. 14, the device 200 includes a first area 272 and a second area 272 that is adjacent to the first area 272. The magnetic strip 270 is positioned in the first area 272 while the first, second, third and fourth antennas 230, 240, 280, 290 are positioned in the adjacent second area 272. The magnetic strip 270 and the first, second, third and fourth antennas 230, 240, 280, 290 need to be positioned in adjacent areas of the device 200 because the magnetic strip 270 will interfere with the operation of the first, second, third and fourth antennas 230, 240, 280, 290 if there is any overlap between the magnetic strip 270 and the first, second, third and fourth antennas 230, 240, 280, 290.

In some embodiments, the devices 100, 200 described herein may be designed to operate based on the ISO/IEC 14443 specification such that the devices 100, 200 power on when a low power radio frequency signal of 13.56 MHz is applied near the RFID device. It should be noted that other frequencies may be used (e.g., a 125 KHz channel, a 134 KHz Channel or a 915 MHz carrier).

The integrated circuits 120, 220 described herein can be of any type. As used herein, integrated circuit means any type of circuit such as, but not limited to, a microprocessor, a microcontroller or a digital signal processor. In addition, many types of circuits may form part of the integrated circuits 120, 220. Some example circuits include a custom circuit or an application-specific integrated circuit such as those that are typically used in RFID devices.

FIGS. 1 through 14 are merely representational and are not drawn to scale. Certain proportions thereof may be exaggerated while others may be minimized. The elements, materials, geometries, dimensions, and sequence of operations can all be varied to suit particular packaging requirements.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. An electronic information device comprising:
an integrated circuit embedded within the device;
a first antenna embedded within the device and connected to the integrated circuit, the first antenna being oriented within a first plane; and
a second antenna embedded within the device and connected to the integrated circuit, the second antenna being oriented within a second plane, wherein the second plane is substantially parallel to the first plane.

2. The device of claim 1 wherein the first antenna is a coil antenna and the first antenna is a coil antenna.

3. The device of claim 2 wherein the first antenna includes multiple loops and the second antenna includes multiple loops.

4. The device of claim 3 wherein the device includes multiple layers such that first antenna is in a first layer and the second antenna in a second layer that is not adjacent to the first layer.

5. The device of claim 3 wherein the first antenna is aligned with the second antenna.

6. The device of claim 5 wherein the device includes four corners such that a portion of the first antenna is positioned adjacent to each of the corners and a portion of the second antenna is positioned adjacent to each of the corners.

7. The device of claim 3 wherein the first antenna is offset from the second antenna.

8. The device of claim 2 wherein the device includes an upper surface, a lower surface and outer edges such that the first and second antenna are positioned adjacent to the outer edges of the device.

9. The device of claim 2 wherein the device includes an upper surface and a lower surface such that the first and second antenna are positioned between the upper surface and the lower surface of the device.

10. An electronic information device comprising:
an integrated circuit embedded within the device;
a first antenna embedded within the device and connected to the integrated circuit, the first antenna being oriented within a first plane;
a second antenna embedded within the device and connected to the integrated circuit, the second antenna being oriented within a second plane, wherein the second plane is substantially parallel to the first plane; and
a magnetic strip on a surface of the device, wherein the device includes a first area and a second area that is adjacent to the first area, the magnetic strip being positioned within the first area and the first and second antenna being positioned within the second area.

11. An electronic information device comprising:
an integrated circuit embedded within the device;
a first antenna embedded within the device and connected to the integrated circuit, the first antenna being oriented within a first plane;
a second antenna embedded within the device and connected to the integrated circuit, the second antenna being oriented within a second plane, wherein the second plane is substantially parallel to the first plane;
a third antenna embedded within the device and connected to the integrated circuit, the third antenna being oriented within a third plane, wherein the third plane is substantially parallel to the first plane and the second plane; and
a fourth antenna embedded within the device and connected to the integrated circuit, the fourth antenna being oriented within a third plane, wherein the fourth plane is substantially parallel to the third plane.

12. The device of claim 11 wherein the first, second, third and fourth antennas are each coil antennas.

13. The device of claim 11 wherein the first, second, third and fourth antennas each include multiple loops.

14. The device of claim 13 wherein the device includes multiple layers such that first antenna is in a first layer, the second antenna in a second layer that is not adjacent to the first layer, the third antenna in a third layer that is not adjacent to the first and second layers and the fourth antenna in a fourth layer that is not adjacent to the first, second and third layers.

15. The device of claim 12 wherein the first, second, third and fourth antennas are aligned.

16. The device of claim 15 wherein the device includes four corners such that a portion of the first antenna is positioned adjacent to each of the corners, a portion of the second antenna is positioned adjacent to each of the corners, a portion of the third antenna is positioned adjacent to each of the corners and a portion of the fourth antenna is positioned adjacent to each of the corners.

17. The device of claim 12 wherein the first antenna is offset from the second, third and fourth antennas, the second antenna is offset from the first, third and fourth antennas, the third antenna is offset from the first, second and fourth antennas and the fourth antenna is offset from the first, second and third antennas.

18. The device of claim 12 wherein the device includes an upper surface, a lower surface and outer edges such that the first, second and fourth antennas are positioned adjacent to the outer edges of the device.

19. The device of claim 12 wherein the device includes an upper surface and a lower surface such that the first, second and fourth antennas are positioned between the upper surface and the lower surface of the device.

20. The device of claim 11 further comprising:
a magnetic strip on a surface of the device, wherein the device includes a first area and a second area that is adjacent to the first area, the magnetic strip being positioned within the first area and the first, second, third and fourth antennas being positioned within the second area.
